(19) United States
(12) Patent Application Publication
(10) Pub. No.: US 2016/0331630 A1
(43) Pub. Date: Nov. 17, 2016

(54) BOWEL EVACUATION AID

(71) Applicant: TURDLE TIME, LLC., Ventura, CA (US)

(72) Inventor: Todd Wiseman, Ventura, CA (US)

(21) Appl. No.: 14/712,844

(22) Filed: May 14, 2015

(51) Int. Cl. A61H 21/00; A61H 23/00

(52) U.S. Cl. CPC A61H 21/00; A61H 23/004; A61H 2201/0207

(57) ABSTRACT

A bowel evacuation aid is provided. Generally, the apparatus includes an elongated member having a cross sectional profile of a lengthwise cross section of an American football with one end flattened, a first side having grooves for heat redistribution and a second side having a handhold depression.

### FIELD OF THE INVENTION

The field of the invention relates to the field of bowel evacuation and more particularly to a device that stimulates the colon.

### BACKGROUND OF THE INVENTION

Humans are designed to squat while evacuating the bowels. While squatting, body weight is born by the feet, not by the rear-end as is the case when sitting on a toilet. In this squatting position with the weight on the feet, the thighs contact the abdominal wall, placing beneficial pressure on the colon. This pressure helps to gently move waste through and out of the colon. The standard, modern toilet has users in a generally upright position with the body weight resting on the rear-end. This position negates the natural squatting posture and provides less ease and efficiency for bowel evacuation. Without the support and beneficial pressure of the thighs contacting the abdominal wall, people are left to push and strain. This leads to numerous health related problems including hemorrhoids, constipation and others.

Previous attempts to replicate the benefits of squatting have focused on positioning of the body to change the angle of the Puborectalis and other organs.

Thus, needs exist for improved techniques to simulate the benefits of a natural squatting posture including pressure on the colon when evacuating bowels.

### SUMMARY

Provided herein are embodiments of bowel evacuation aid devices and methods that provide simulation of natural squatting postures which are designed to replicate the direct touch and beneficial pressure applied against the abdominal wall and colon by the thighs. The configuration of these devices is described in detail by way of various embodiments which are only examples.

Other systems, devices, methods, features and advantages of the subject matter described herein will be or will become apparent to one with skill in the art upon examination of the following figures and detailed description. It is intended that all such additional devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWING(S)

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

Illustrated in the accompanying drawing(s) is at least one of the best mode embodiments of the present invention In such drawing(s):

FIG. 1 is an example embodiment of a perspective view of a device.

FIG. 2A is an example embodiment of a side view of a device.

FIG. 2B is an example embodiment of a diagram of the side view shown in FIG. 2A.

FIG. 3A is an example embodiment of a side view of a device.

FIG. 3B is an example embodiment of a diagram of the side view shown in FIG. 2A.

FIG. 4A is an example embodiment of an initial use step.

FIG. 4B is an example embodiment of a subsequent use step.

FIG. 5 is an example embodiment of a side view of a device with components.

FIG. 6 is an example embodiment of a perspective view of a device.

### DETAILED DESCRIPTION

Before the present subject matter is described in detail, it is to be understood that this disclosure is not limited to the particular embodiments described, as such may vary. It is also to be understood that the terminology used herein is for the purpose of describing particular embodiments only, and is not intended to be limiting, since the scope of the present disclosure will be limited only by the appended claims.

Provided herein are device and methods for evacuating the bowels. The devices and methods described herein can be configured to aid in the evacuation as would be accomplished naturally through a squatting posture. This application includes improvements on the designs included in U.S. patent application Ser. No. 13/970,979 for Bowel Evacuation Aid, which is commonly owned.

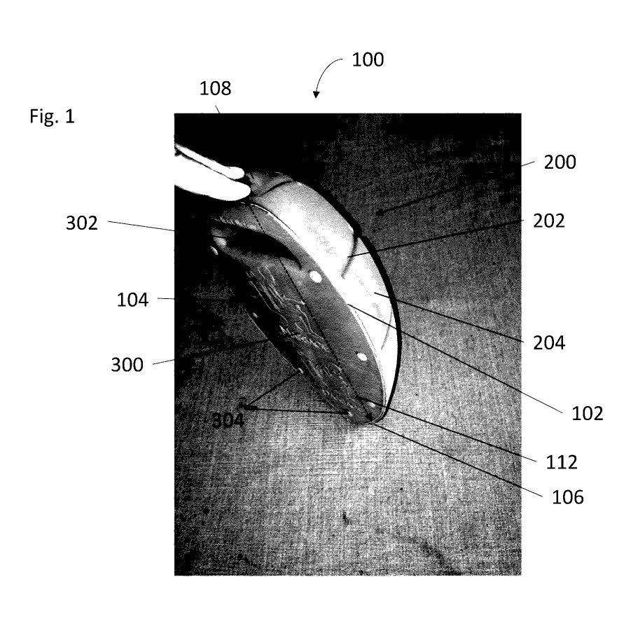

FIG. 1 is an example embodiment of a perspective view of a device 100. In the example embodiment a device 100 can have a flat second side 300 with upper sloping long edge 102 and lower sloping long edge 104 meeting at a rounded tip 106 and flat edge 108. An analogous shape of a cross section along a wide axis 112 of device 100 can be a cross section of a football with a flat end 108. In some embodiments the shape can be more elliptical while in other embodiments the shape can be more round. Device 100 is typically monolithic. Device 100 can have a wide axis 112 which is typically the distance between a human torso and human knee, the length of an upper leg, when seated.

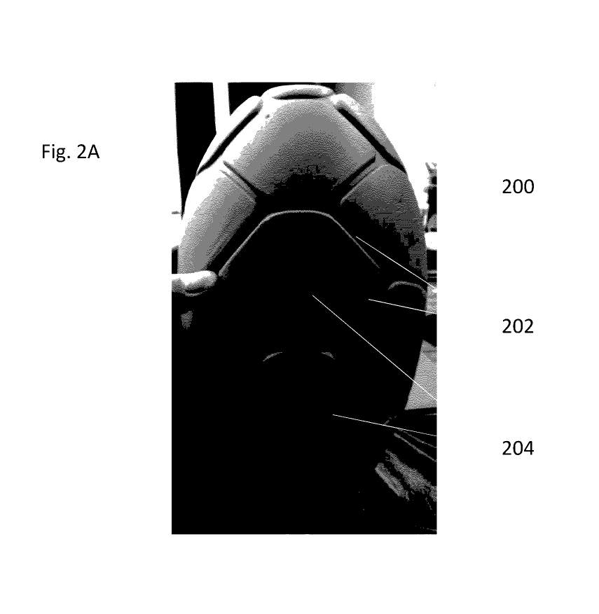

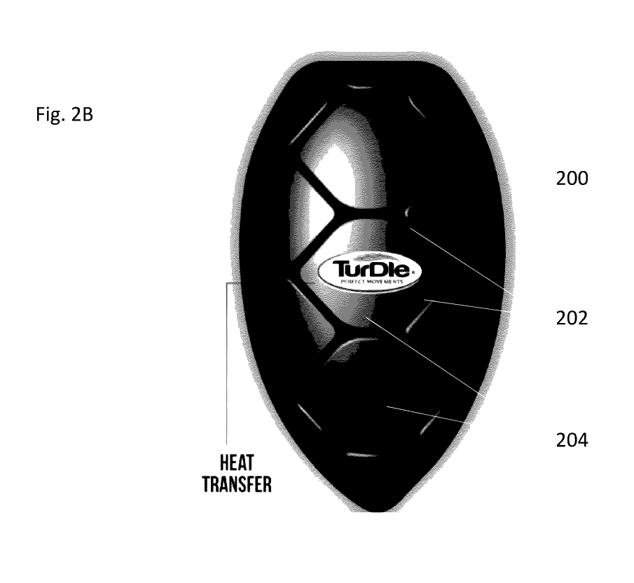

FIG. 2A is an example embodiment of a first side 200 view of a device 100. In the example embodiment grooves 202 are shown which a user can use as a grip enhancement to provide leverage on the device while holding it against the lower stomach. These grooves 202 can be deep enough for fingertips or digits to grasp. Grooves 202 can cross first surface such that plate structures 204 exist between grooves 202. In some embodiments, plates 204 can be a size that a human hand can comfortably grip or grasp.

FIG. 2B is an example embodiment of a diagram of the first side 200 view shown in FIG. 2A. In the example embodiment the grooves 202 can be used as a heat transfer mechanism which channel body or other heat away from a user's hands and arms while grasping the device 100. This can increase a user's comfort and allow the user to maintain use for longer periods of time, as necessary. Alternatively or additionally, grooves 202 can allow cool air to travel across first side 200. First side 200 of device 100 can be rounded such that its surface is not parallel with second side 300. The curvature of first side 200 can assist grooves 202 in heat transfer properties. In some embodiments the surface of device 100 can be waterproof such that sweat will not penetrate device 100. Grooves 202 can also channel sweat away from a user's skin.

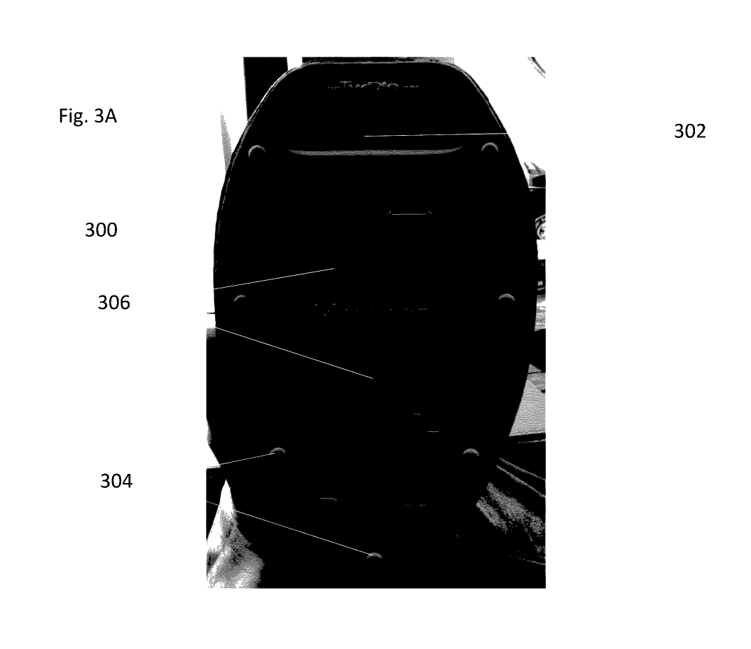

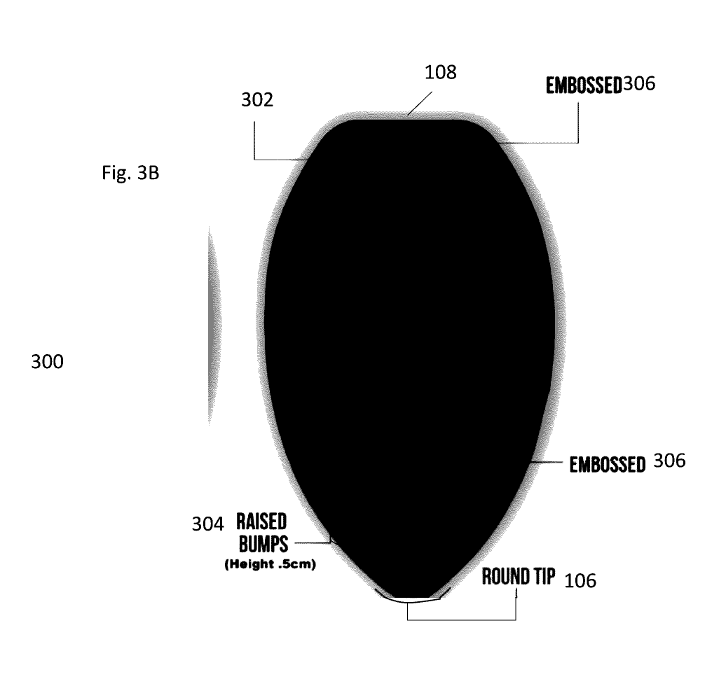

FIG. 3A is an example embodiment of a second side 300 view of a device 100. In the example embodiment a handhold depression 302 is shown. Handhold depression 302 can allow a user to maintain a high level of control over the device at all times. Handhold depression 302 is parallel lengthwise with flat edge 108. Handhold depression 302 can also have other uses such as a location for hanging on a wall, beam or other location. Various raised nodules 304 are shown near a perimeter of second side 300. These nodules 304 can be used for traction against the user's forearm. Additionally, nodules 304 provide a slight lift platform so the entire second side 300 of device 100 does not lie flat on a floor surface during storage of the device. This can be beneficial in a bathroom environment where a floor surface can become wet and second side 300 of device 100 might otherwise stick to the wet floor due to cohesive forces of the wet surface of the floor and second side 300 of device 100. In the example embodiment nodules 304 are semi-spherical and protrude 0.5 centimeters from a flat surface of second side 300.

FIG. 3B is an example embodiment of a diagram of the second side 300 view shown in FIG. 3A. In the example embodiment embossed use instructions 306 are shown on second side 300 of device 100. Embossed use instructions 306 allow an inexperienced user to instantly understand how to use device 100. Rounded tip 106 of device 100 can allow a user to gently massage their bowels including their colon without injuring themselves. The opposing flat surface 108 can allow a user an additional location at which to grip device 100.

In some embodiments, each of the first side 200 and second side 300 can be identical. As such, each side can have grooves 202 as in FIGS. 2A-2B, each side can have handhold depressions 302 as in FIGS. 3A-3B, each side could be a hybrid of FIGS. 2A-2B and 3A-3B combining beneficial features, or each side can be different. Similarly, sloping sides 102, 104 and flat side 108 of the device can have beneficial features including grooves, handhold depressions and others that can be identical to or differing from each other in various embodiments.

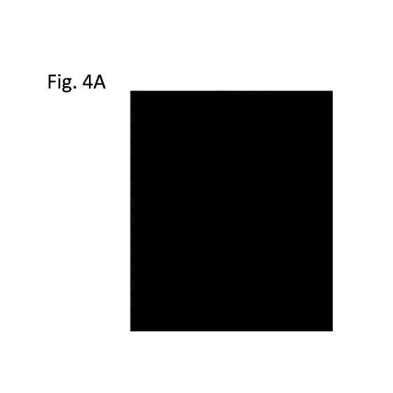

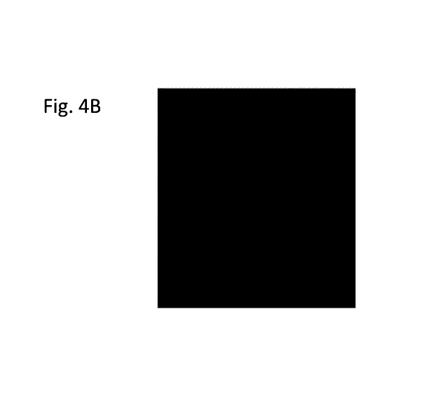

FIG. 4A is an example embodiment of an initial use step. In the example embodiment a first use step can be a user sitting on a toilet or other sanitation fixture for the disposal of human urine and feces. The user can grasp device 100 using the handholds 302, grooves 202 and other surfaces and features of the device as desired. The user can move device 100 horizontally toward and away from their trunk along their lap in addition to other motions. Other motions can include vertically up and down their stomach area. Still other motions can include rotational movements of the device about its rounded tip with the rounded tip held snug against the user's stomach area near the colon.

FIG. 4B is an example embodiment of a subsequent use step. In the example embodiment the user can defecate by normal muscular contraction in the walls of the colon by the process of peristalsis. To assist the user may bend their upper trunk forward over device 100 while performing the movements described with respect to FIG. 4A above. The process of bending the upper trunk over the device can simulate the natural process of an individual's thighs having a force against the individual's trunk as a human who might defecate in a squatting position without the use of the modern toilet.

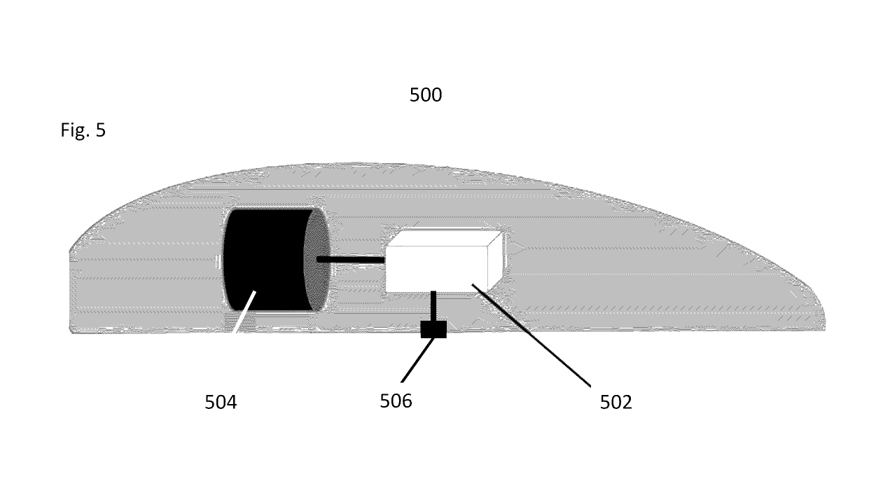

FIG. 5 is an example embodiment of a side view of a device 500 with components. In the example embodiment a control component 506 can be a power on/off button, an interactive display such as a touchscreen device, a display with separate buttons, or another similar component. A drive component 502 can include power such as a battery in addition to regulation circuitry which can be an integrated circuit, memory storing instructions and processors for regulating a usable component 504. Power sources such as batteries can be removable and replaceable as required by particular embodiments. Additionally, in some embodiments plug locations, power cords and other related infrastructure can be included. Usable component 504 can be a vibration device, a heating device, a cooling device, an acoustic device such as a speaker, a spring loaded element, an articulated device, a trigger device, a fluid transfer device, a rotation device, a pulsation device, or others. Control component 506 can be electronically, mechanically or electro-mechanically coupled to drive component 502 and drive component can be electronically, mechanically or electro-mechanically coupled to usable component 504. Locations of control component 506, drive component 502 and usable component 504 can vary according to various embodiments with part of control component located near a surface of device 500.

In a typical electro-mechanical vibrating embodiment, a user can activate usable component 504 by interacting with control component 506 which can send signals to drive component 502. Drive component 502 can then activate usable component 504 by, for instance, powering usable component 504 which vibrates device 500 to create stimulating vibrations which can be beneficial for colon stimulation to trigger bowel movements. Different modes can be activated in some embodiments with variable vibration or pulsation, variable or multiple frequencies in acoustic embodiments, or others.

Similarly, in a heating embodiment where usable component 504 is a heater, a user can activate the heater in order to send stimulating heat to a targeted location on the device to stimulate bowel movements.

In some mechanical embodiments, drive component 502 can be integrated with usable component 504. As such, activation can cause a small mechanical trigger to activate a loaded spring which can propel a small, directed push through the device to a colon area of a user. The spring can be reloaded for repeated use.

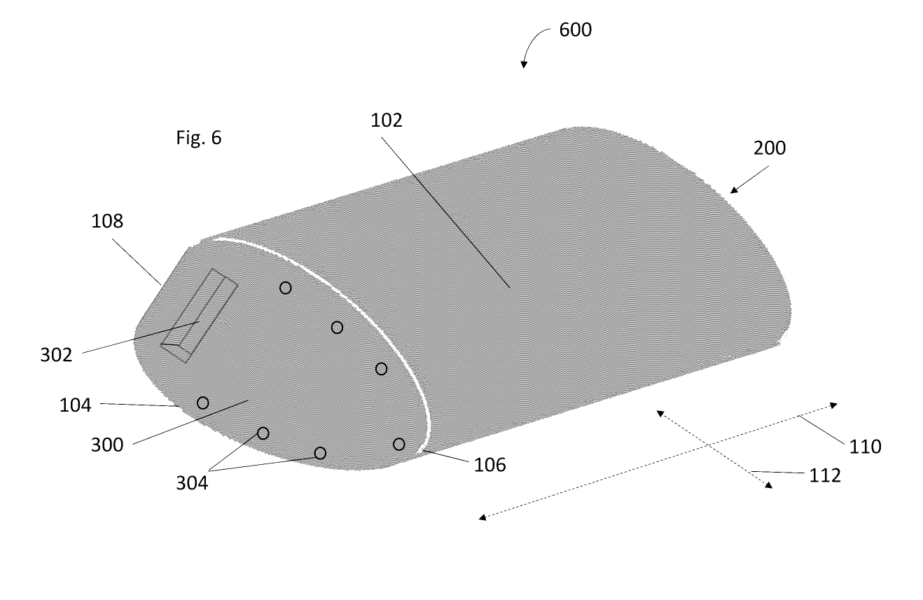

FIG. 6 is an example embodiment of a perspective view of a device. Device 600 can have a long axis 110 which is at least long enough to fit across a human lap, the length across two human upper legs placed next to each other when seated. Device 100 can have a wide axis 112 which is typically the distance between a human torso and human knee, the length of an upper leg, when seated.

In some embodiments described herein, devices can be inflatable with air, water or other liquids or other fluids. Alternatively or additionally, parts or all of the device can be foam, recycled foam or others. Generally, materials for the device are soft but firm so that a user will not injure himself or herself although in some embodiments other more rigid materials can be used such as wood or stone. Covers for devices are contemplated which can be comprised of cotton, stretch-fabric such as Spandex, polyester, wool, blends or other fabrics. In general, these can be removable and washable by a user and may include zippers, buttons, hook and loop fasteners, or others.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. An apparatus to aid in the evacuation of human bowels, comprising:
an elongated member having a cross sectional profile of a lengthwise cross section of an American football with one end flattened;
a first side having grooves for heat redistribution; and
a second side having a handhold depression.

2. The apparatus of claim 1, wherein the first side further comprises a curved side with a rounded profile.

3. The apparatus of claim 1, wherein the second side further comprises a flat side.

4. The apparatus of claim 1, wherein the second side further comprises at least one raised nodule.

5. The apparatus of claim 1, wherein the apparatus fits on a human lap.

6. The apparatus of claim 1, wherein the apparatus is comprised of recycled foam.

7. The apparatus of claim 1, wherein the apparatus further comprises:
a control component;
a drive component; and
a usable component.

8. The apparatus of claim 7, wherein the control component comprises a power button.

9. The apparatus of claim 7, wherein the drive component comprises a power supply and regulation circuitry.

10. The apparatus of claim 7, wherein the usable component comprises a vibration component.

11. The apparatus of claim 7, wherein the usable component comprises a heating component.

12. The apparatus of claim 7, wherein the usable component comprises an acoustic component.

13. The apparatus of claim 7, wherein the drive component and usable component comprise a mechanical spring device which can be reset from a second configuration to a first configuration after activation from a first configuration using the control component.
